(19) United States
(12) Patent Application Publication
(10) Pub. No.: US 2010/0162225 A1
(43) Pub. Date: Jun. 24, 2010

(54) CROSS-PRODUCT REFACTORING APPARATUS AND METHOD

(75) Inventors: Wei Huang, Thornhill (CA); Vladimir Klicnik, Oshawa (CA); Grace Hai Yan Lo, North York (CA); Curtis Reed Miles, Stouffville (CA); William Gerald O'Farrell, Markham (CA); Udesh Herath Senaratne, Toronto (CA)

Correspondence Address: IBM Corp. ( Raleigh), c/o Nelson and Nelson, 2984 E. Evergreen Ave., Salt Lake City, UT, 84109, US

(73) Assignee: INTERNATIONAL BUSINESS MACHINES CORPORATION, Armonk, NY (US)

(21) Appl. No.: 12/339,615

(22) Filed: Dec. 19, 2008

(51) Int. Cl. G06F 9/44

(52) U.S. Cl. 717/171

(57) ABSTRACT

A method for automatically propagating refactoring changes across multiple applications is disclosed herein. In one embodiment, such a method may include receiving a primary change for an artifact managed by a first application. The first application may calculate referencing changes necessitated by the primary change for artifacts managed by the first application. The first application may then generate a difference notification documenting the primary and referencing changes. This difference notification may be transmitted to a second application. The second application may analyze the difference notification to determine what refactoring changes are needed for artifacts managed by the second application. The second application may then implement the refactoring changes to the artifacts managed thereby. A corresponding apparatus and computer program product are also disclosed and claimed herein.

### BACKGROUND

### Field of the Invention

This invention relates to apparatus and methods for developing and maintaining software, and more particularly to apparatus and methods for refactoring software.

### BACKGROUND OF THE INVENTION

Code refactoring refers to the process of changing program code to make it more amenable to change, improve its readability, or simplify its structure, while preserving the code's functionality and behavior. One example of refactoring may include a user modifying a construct (a primary change), and then modifying all other referencing constructs such that the syntactical and semantic correctness of the program is preserved (referencing changes). For example, renaming a method in a source artifact (e.g., a source class or file) is an example of a primary change, and updating all calls made to that method in that artifact or other artifacts are examples of referencing changes.

Some integrated development environments (IDEs) provide automated refactoring tools. One example of such a product is the Eclipse IDE. Software development applications such as Eclipse typically include refactoring tools needed to implement referencing changes when a user specifies a primary change. For instance, if the primary change involves renaming a method, the automated refactoring tools may be configured to update all corresponding method calls in all source artifacts managed by the software development application.

In general, automated refactoring tools require some sort of indexing to establish relationships between managed artifacts. Indexing enables the software development application to identify all artifacts that need be updated when the user initiates an automated refactoring. A given instance of a software development application can only index references between artifacts it manages, given that it has no knowledge of artifacts it does not manage. This essentially means that the software development application can only maintain correctness of the source artifacts it manages. For example, assume that another software development application manages a mutually exclusive set of artifacts, some of which reference artifacts managed by the first software development application. If an automated refactoring action is initiated in the first application, then artifacts managed by the second application may not preserve their correctness and consistency with artifacts managed by the first application.

In view of the foregoing, what are needed are apparatus and methods to propagate and implement refactoring changes across multiple software development applications, thereby maintaining the correctness and consistency of the artifacts they manage. Ideally, such a feature would be automated and require little if any user intervention.

### SUMMARY

The invention has been developed in response to the present state of the art and, in particular, in response to the problems and needs in the art that have not yet been fully solved by currently available apparatus and methods for refactoring software. Accordingly, the invention has been developed to provide apparatus and methods to propagate refactoring changes across multiple applications. The features and advantages of the invention will become more fully apparent from the following description and appended claims, or may be learned by practice of the invention as set forth hereinafter.

Consistent with the foregoing, a method for automatically propagating refactoring changes across multiple applications is disclosed herein. In one embodiment, such a method may include receiving, by a first application, a primary change for an artifact managed by the first application. The first application may then calculate referencing changes necessitated by the primary change for artifacts managed by the first application. The first application may then generate a difference notification readable by a second application and documenting the primary and referencing changes implemented by the first application. The first application may then transmit the difference notification to the second application. The second application may receive and analyze the difference notification to determine what refactoring changes are needed in the artifacts it manages. The second application may then implement the refactoring changes in the artifacts.

In selected embodiments, the difference notification may be transmitted between the first and second applications by way of a software port, by way of an API call, or over a network. In other embodiments, the first application may write the difference notification to a data repository where it may be later read and implemented by the second application.

A corresponding apparatus and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram of a system showing artifacts managed by two applications;

FIG. 2 is a high-level block diagram showing a real-world example of artifacts managed by two applications;

FIG. 3 is a high-level block diagram showing one embodiment of a method implemented by applications running on the same machine;

FIG. 4 is a high-level block diagram showing one embodiment of a method implemented by applications communicating over a network;

FIG. 5 is a high-level block diagram showing one embodiment of a method implemented by applications connected to a data repository; and

FIG. 6 is a high-level block diagram showing one embodiment of an application incorporating a refactoring module in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, process, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “module,” “system,” or “apparatus.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of processes, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

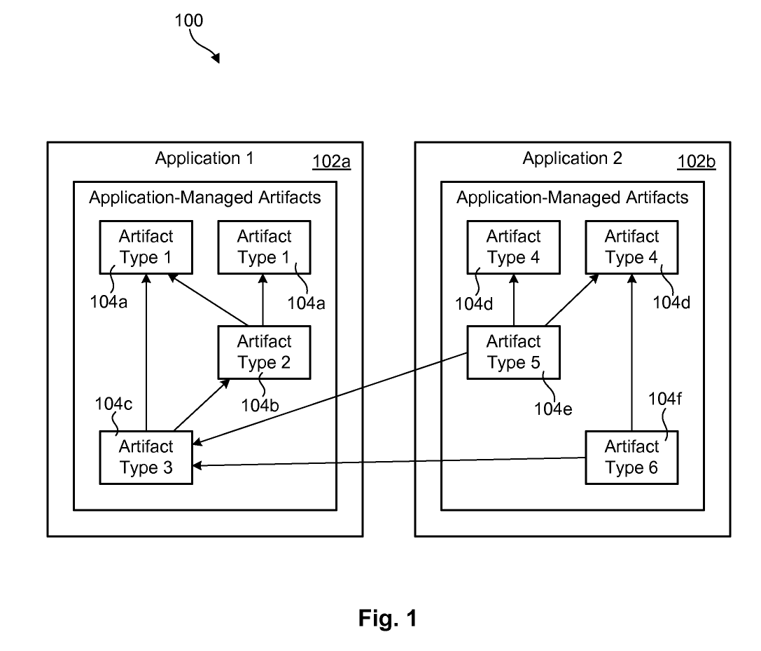

Referring to FIG. 1, one example of a system 100 comprising multiple applications 102a, 102b, each managing different artifacts 104a-f, is illustrated. In certain embodiments, each of the applications 102a, 102b manages artifacts that are all related to one another, such as artifacts that belong to a complex or very large computer program. Such a situation may occur, for example, where two different departments or companies are developing different parts of the same large program using different applications 102a, 102b or different instances 102a, 102b of the same application. For the purposes of this disclosure, the term “artifact” is used to refer to any file, class, object, use case, class diagram, model (e.g., UML model), project plan, programming language construct, or the like. Similarly, the term “application” may refer to a software development application (e.g., a software editor, compiler, interpreter, debugger, or the like), or any application that is used to manage, edit, or create software artifacts of various types.

In selected embodiments, the artifacts 104a-f managed by each of the applications 102a, 102b may depend on or interact with other artifacts 104a-f. For example, where an artifact is a class, the class may define certain methods and attributes that are used or referenced by other artifacts (classes). For example, a class may call methods of other classes or use attributes defined in other classes. Thus, as shown in FIG. 1, an artifact 104c may depend on or reference an artifact 104a and an artifact 104e may depend on or reference an artifact 104d (as indicated by the arrows), and so forth.

As mentioned, these artifacts 104a-f may, in certain embodiments, be managed by different applications 102a, 102b. For example, where the applications 102a, 102b are software development applications 102a, 102b, a first software development application 102a may manage a first set of artifacts 104a-c and a second software development application 102a may manage a second set of artifacts 104d-f. Dependencies may exist between the artifacts 104a-f managed by the different applications 102a, 102b. For example, artifacts 104e, 104f may depend on an artifact 104c, and so forth.

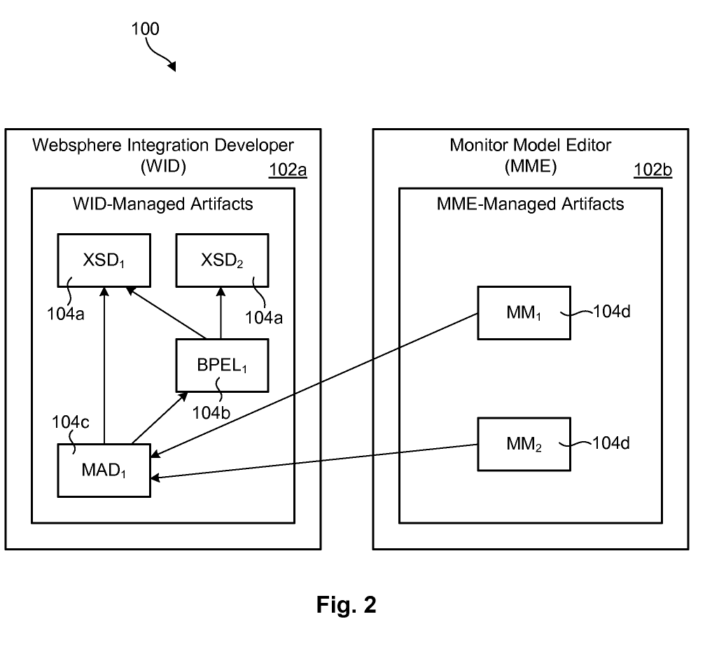

Referring to FIG. 2, one real-world example of a system 100 comprising multiple software development application 102a, 102b is illustrated. Each application 102a, 102b manages a different set of artifacts 104a-d, although the artifacts 104a-d may be related to one another (e.g., reference one another, etc.). In this example, the first application 102a is Websphere Integration Developer (WID) and the second application 102b is Monitor Model Editor (MME), both of which are Eclipse-based products. Websphere Integration Developer and Monitor Model Editor are examples of applications 102a, 102b and are not intended to be limiting.

Among other artifacts, Websphere Integration Developer manages Monitoring Application Descriptor (MAD) artifacts 104c. These MAD artifacts 104c can be described as XML artifacts that can be de-serialized as Eclipse Modeling Framework (EMF) objects. The Monitor Model Editor 102b manages resources called Monitor Model (MM) artifacts 104d. Any given MM artifact 104d may reference one or more MAD artifacts 104c. Furthermore, a MAD artifact 104c itself may be dependent on other types of files that WID manages such as XSD files 104a. Therefore, an MM artifact 104d can indirectly reference several types of artifacts that WID manages. Thus, any change to a MAD artifact 104c, or any change to an artifact that is referenced by a MAD artifact 104c, may also affect MM artifacts 104d. If a change happens to be a refactoring change, then the MM artifacts 104d will need to be updated in order to preserve their correctness and consistency with the WID-managed artifacts 104a-c.

WID provides automated refactoring tools that enable a user to quickly rename files and XML elements defined in the source artifacts that it manages. The underlying refactoring tool uses information stored in an index to determine relationships and references between the various managed artifacts and their elements. Since WID does not manage MM files 104d (and hence is unaware of their existence), the WID refactoring tool is unable to index any of the MM files 104d. As a result, a conventional WID refactoring tool is unable to preserve the correctness of MM files 104d when WID-managed artifacts 104a-c are refactored.

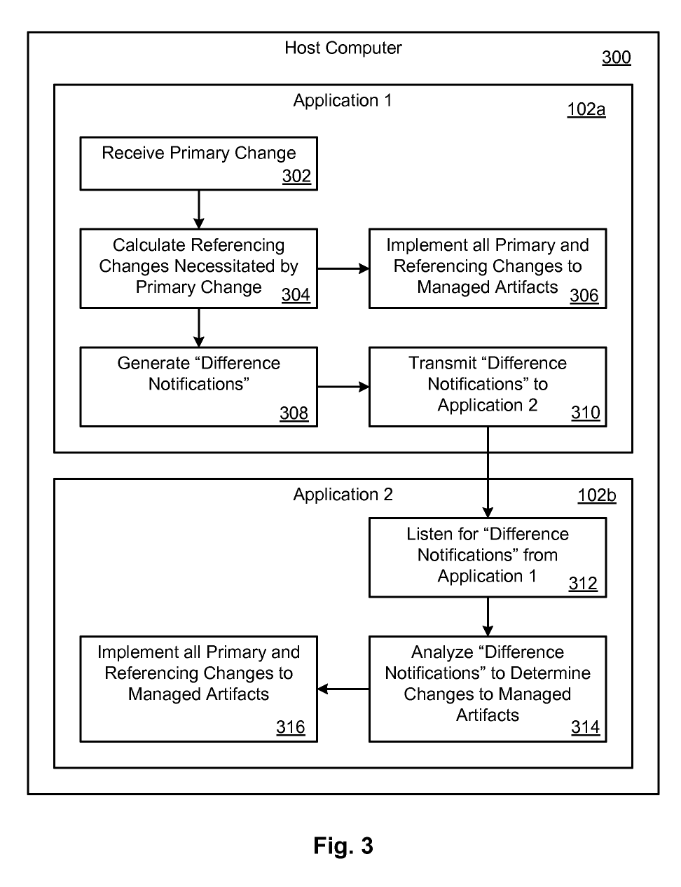

Referring to FIG. 3, in selected embodiments, applications 102a, 102b, such as the Websphere Integration Developer and Monitor Model Editor previously discussed, may be configured to support a refactoring method in accordance with the invention. FIG. 3 shows an embodiment where the method is implemented in a pair of applications 102a, 102b residing on a single computer system 300. The applications 102a, 102b may be entirely different applications (e.g., the Websphere Integration Developer and the Monitor Model Editor described above), or be different instances of the same application 102a, 102b (e.g., two instances of Websphere Integration Developer).

As shown, a first application 102a may be configured to receive 302 a primary change from a user or other source. The first application 102a may then calculate 304 referencing changes for artifacts 104 managed by the first application 102a that are necessitated by the primary change. The first application 102a may use an index or other internal referencing system in order to determine the referencing changes. The first application 102a may then implement the primary and referencing changes in the artifacts 104 that are managed by the first application 102a.

The first application 102a may be configured to generate 308 one or more difference notifications. The difference notifications may document the primary and referencing changes that were performed in the first application 102a. These difference notifications may be designed to have a desired syntax, semantics, and formatting that is readable by other applications. In certain embodiments, the difference notifications may be formatted as XML or other standardized documents. In any case, the difference notifications may be formatted and designed such that they are understood by each of the applications 102a, 102b. This may provide a loosely coupled method for communication refactoring changes between the applications 102a, 102b.

Once the difference notifications are generated 308, the notifications may be transmitted 310 to a second application 102b via an established protocol. This may be accomplished, for example, by transmitting the difference notifications using a local API call. The second application 102b may be configured to listen 312 for this communication. Use of a local API for communications is possible, for example, if both applications 102a, 102b are running in a shell shared environment. If this is not the case, the first applications 102a could also send a serialized presentation of the change notification to a software port that the second application 102b is listening to.

When the second application 102b receives the difference notification, the second application 102b may analyze 314 the difference notification to determine what changes were made to the artifacts of the first application 102a. The second application 102b may then determine what corresponding refactoring changes are needed for artifacts 104 managed by the second application 102b. Once the refactoring changes are determined, the second application 102b may search for artifacts 104 that are affected and implement the changes to the artifacts 104. In this way, the first and second applications 102a, 102b may maintain artifacts 104 that are correct and consistent with one another. This may be accomplished automatically and in real-time without the need for a user to manually synchronize the two applications 102a, 102b.

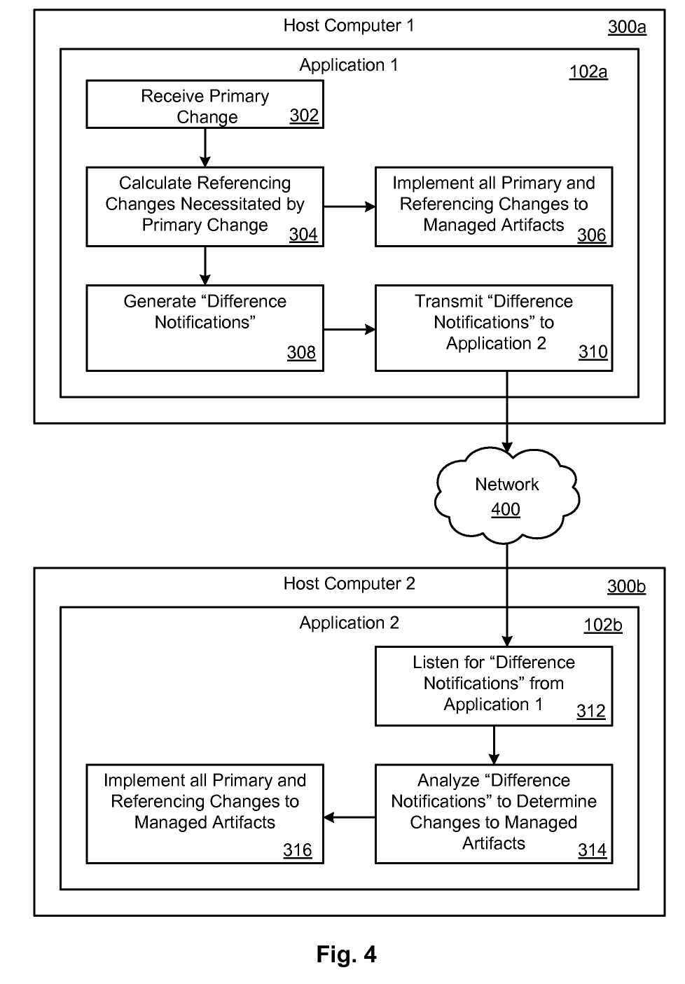

FIG. 4 shows an alternative embodiment of the system illustrated in FIG. 3. In this embodiment, each of the applications 102a, 102b are located on different computers 300a, 300b, which are connected by a network 400. The network 400 may include, for example, a local area network (LAN), a wide area network (WAN), the Internet, or the like. The first application 102a may generate difference notifications that are transmitted to the second application 102b over the network 400. The first application 102a may communicate with the second application 102b by way of a software port or using a remote API (such as the REST API) if the applications 102a, 102b communicate over the Internet. In general, any suitable method or protocol for communicating locally or remotely may be used to transmit difference notifications between the applications 102a, 102b.

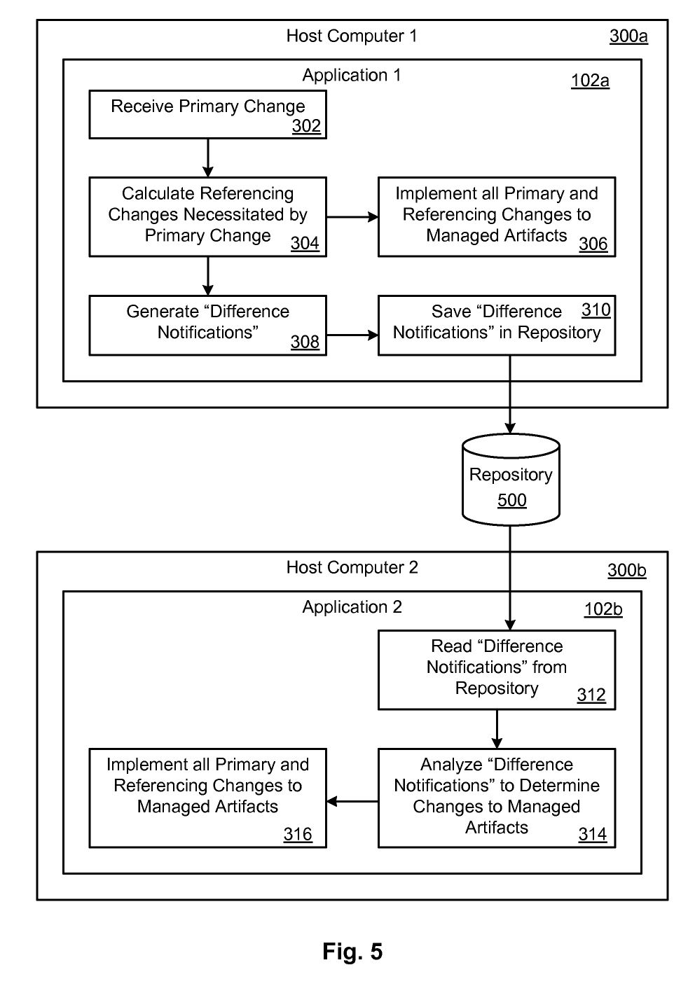

FIG. 5 shows another alternative embodiment of the system illustrated in FIGS. 3 and 4. In this embodiment, each of the applications 102a, 102b communicate with a data repository 500. Difference notifications generated by the first application 102a may be transmitted (i.e., written) to the data repository 500. The second application 102b may then read the difference notifications from the data repository 500 and modify its artifacts accordingly. This allows for a time delay between the time the first application 102a writes the difference notifications and the time the second application 102b reads the difference notifications. Such an embodiment may be helpful where the first and second applications 102a, 102b cannot communicate with one another (e.g., where a network is not present) or where one application cannot immediately respond to the other. In certain embodiments, the second application 102b may periodically poll the repository 500 to determine if any difference notifications have been written thereto. If so, the second application 102b may read or download the difference notifications to implement the changes contained therein.

The data repository 500 may be incorporated into the first application, the second application 102b, or be separate from either the first or second applications 102a, 102b. For example, the data repository 500 may include a memory device, such as RAM, or a disk drive connected locally to either the first or second computers 300a, 300b. The data repository 500 may also include a network drive, server, or other storage device that is physically separated from the first and second computers 300a, 300b but is nevertheless accessible and readable by the first and second application 102a, 102b. In other embodiments, the data repository 500 is a removable memory device, such as a flash memory device, memory card, CD-ROM, portable disk drive, or the like, that may be transported from one computer 300a to another 300b to transfer difference notifications therebetween.

In the illustrated embodiment, each of the applications 102a, 102b are located on different computers 300a, 300b and communicate with the data repository 500 over a network. In other embodiments, the applications 102a, 102b may be located on the same computer 300 and communicate with the repository 500 locally.

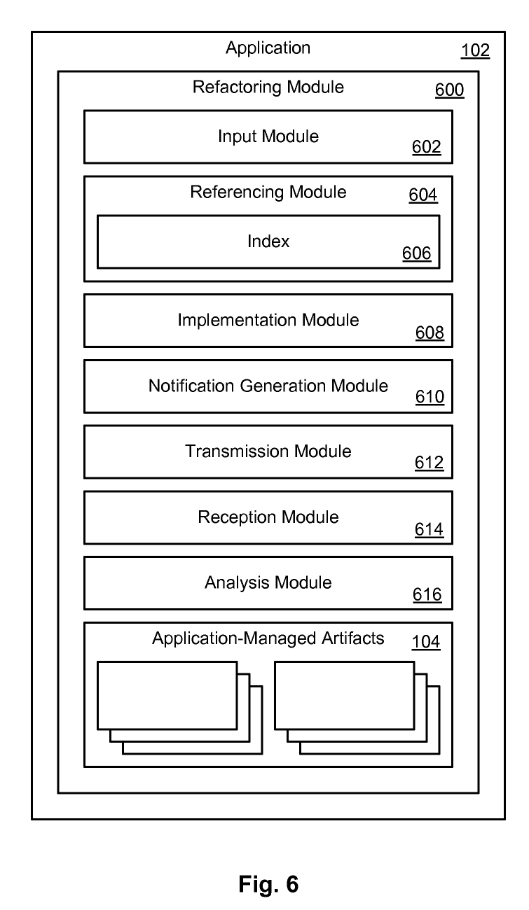

Referring to FIG. 6, the methods and processes disclosed herein may be implemented in one or more modules, which may be collectively referred to as a refactoring module 600. The refactoring module 600 may be incorporated into the application 102 orbe provided as a plug-in or extension to the application 102. The modules are presented only by way of example and are not intended to be limiting. In selected embodiments, the refactoring module 600 may include more or fewer modules than those illustrated. Furthermore, the functionality of the modules may be combined into fewer modules or be divided into multiple modules in different embodiments.

In selected embodiments, the refactoring module 600 may include one or more of an input module 602, a referencing module 604, an implementation module 608, a notification generation module 610, a transmission module 612, a reception module 614, and an analysis module 616. The input module 602 may be configured to receive a primary change, such as a change to a method or variable name from a user or other source. A referencing module 604 may then calculate referencing changes necessitated by the primary change for artifacts 104 that are managed by the application 102. In selected embodiments, the referencing module 604 may use an index 606 or other internal referencing system 606 to determine and keep track of the referencing changes. An implementation module 608 may then implement the primary and referencing changes to the artifacts 104 managed by the application 102.

A notification generation module 610 may be configured to generate one or more difference notifications documenting the primary and referencing changes. These difference notifications may have any desired level of granularity. For example, a difference notification may be generated for every change occurring to the application-managed artifacts 104, no matter how minor (small granularity). In other embodiments, a difference notification may contain several changes which have accumulated or been performed over a period of time (large granularity).

A transmission module 612 may be configured to transmit the difference notifications. These may be either transmitted directly to another application or written to a data repository 500 where they may be read or forwarded to another application. In selected embodiments, the transmission module 612 may be configured to transmit a difference notification each time one is generated. In other embodiments, the transmission module 612 may transmit difference notifications at set time intervals or once a certain number of difference notifications have accumulated.

A reception module 614 may be configured to receive difference notifications from other applications. An analysis module 616 may be configured to analyze the difference notifications to determine what refactoring changes are needed to the artifacts 104 managed by the application 102. The implementation module 608 may then search for artifacts that are affected and implement the changes. Thus, the implementation module 608 may be used to implement refactoring changes initiated by a user of the application 200 or implement refactoring changes received from another application by way of a difference notification.

The flowchart and block diagrams in the Figures illustrate the architecture, functionality, and operation of possible implementations of systems, processes, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for automatically propagating refactoring changes across multiple applications, the method comprising:
receiving a primary change for an artifact managed by a first application;
calculating referencing changes necessitated by the primary change for artifacts managed by the first application;
generating a difference notification readable by a second application, the difference notification documenting the primary and referencing changes in the first application;
transmitting the difference notification to the second application;
analyzing, by the second application, the difference notification to determine what refactoring changes are needed for artifacts managed by the second application; and
implementing the refactoring changes to the artifacts managed by the second application.

2. The method of claim 1, wherein transmitting comprises transmitting over a network.

3. The method of claim 1, wherein transmitting comprises transmitting by way of a software port.

4. The method of claim 1, wherein transmitting comprises writing, by the first application, the difference notification to a data repository.

5. The method of claim 4, wherein transmitting comprises reading, by the second application, the difference notification from the data repository.

6. The method of claim 1, where transmitting comprises transmitting via an API call.

7. The method of claim 1, wherein the first and second applications are software development applications.

8. A computer program product for automatically propagating refactoring changes across multiple applications, the computer program product comprising a computer-usable medium having computer-usable program code embodied therein, the computer-usable program code comprising:
computer-useable program code to receive a primary change for an artifact managed by a first application;
computer-useable program code to calculate referencing changes necessitated by the primary change for artifacts managed by the first application;
computer-useable program code to generate a difference notification readable by a second application, the difference notification documenting the primary and referencing changes of the first application; and
computer-useable program code to transmit the difference notification to the second application, thereby enabling the second application to implement refactoring changes that are consistent with the primary and referencing changes in the difference notification.

9. The computer program product of claim 8, further comprising computer-useable program code to transmit the difference notification over a network.

10. The computer program product of claim 8, further comprising computer-useable program code to transmit the difference notification through a software port.

11. The computer program product of claim 8, further comprising computer-useable program code to write the difference notification to a data repository, thereby enabling the second application to read the difference notification from the data repository.

12. The computer program product of claim 8, further comprising computer-useable program code to transmit the difference notification via an API call.

13. The computer program product of claim 8, wherein the first and second applications are software development products.

14. An apparatus for automatically propagating refactoring changes across multiple applications, the apparatus comprising:
an input module for receiving a primary change for an artifact managed by a first application;
a referencing module to calculate referencing changes necessitated by the primary change for artifacts managed by the first application;
a notification generation module to generate a difference notification readable by a second application, the difference notification documenting the primary and referencing changes in the first application;
a transmission module to transmit the difference notification to the second application, thereby enabling the second application to implement refactoring changes that are consistent with the primary and referencing changes documented in the difference notification.

15. The apparatus of claim 14, wherein the transmission module is configured transmit the difference notification over a network.

16. The apparatus of claim 14, wherein the transmission module is configured transmit the difference notification through a software port.

17. The apparatus of claim 14, wherein the transmission module is configured to write the difference notification to a data repository for reading by the second application.

18. The apparatus of claim 14, wherein the transmission module is configured to transmit the difference notification via an API call.

19. The apparatus of claim 14, wherein the first and second applications are software development products.
